(19) United States
(12) Patent Application Publication
(10) Pub. No.: US 2018/0370346 A1
(43) Pub. Date: Dec. 27, 2018

(54) INTEGRATED ALTERNATOR

(71) Applicants: HYUNDAI MOTOR COMPANY, Seoul (KR); KIA MOTORS CORPORATION, Seoul (KR)

(72) Inventor: Mark SHIRLEY, Albion, MI (US)

(73) Assignees: HYUNDAI MOTOR COMPANY, Seoul (KR); KIA MOTORS CORPORATION, Seoul (KR)

(21) Appl. No.: 15/631,545

(22) Filed: Jun. 23, 2017

(51) Int. Cl. B60K 6/448; B60K 6/24; B60K 6/405

(52) U.S. Cl. CPC B60K 6/448; B60W 30/20; B60K 6/405; B60K 6/24

(57) ABSTRACT

An integrated alternator for a vehicle having an engine is provided. The integrated alternator may include: a stator including stator windings; a rotor disposed inside of the stator and including field windings contained within an inner core and an outer core; a slip ring to supply a field current to the field winding; brushes to be in sliding contact with the slip ring; and a housing covering the stator, the slip ring, and the brushes and mounted on one side of an engine. In particular, the rotor further includes a damper layer positioned between the inner and outer cores to absorb vibration generated by the engine, and the rotor is directly fixed on an crankshaft of the engine to rotate with the crankshaft.

### FIELD

The present disclosure relates to an alternator for a vehicle, which is driven by an internal combustion engine.

### BACKGROUND

The statements in this section merely provide background information related to the present disclosure and may not constitute prior art.

Alternators are used in modern automobiles to charge a battery and to power the electrical devices when an engine is running. In general, the automotive alternator is driven by an internal combustion engine to supply electric power to loads and charge the battery. A conventional automotive alternator includes a stator, and a rotor driven by the internal combustion engine, a slip ring to supply a field current to windings of the rotor, and brushes which is in sliding contact with the slip ring.

As alternators are recently desired to lower current requirements and reduce copper usage in a vehicle, a high voltage alternator (e.g., 42 or 48 V alternator) has been developed. However, increased power recuperation in the vehicle incorporating the high voltage alternator contributes to reducing emissions, for example, Green House Gas (“GHG”) emissions.

In general, as illustrated in FIG. 1, a high voltage alternator 30 is arranged between an engine 10 and a transmission 20. More specifically, the alternator 30 is mounted on one side of the engine (i.e., on a flywheel 50 side), and a damper 40 is mounted on the other side of the engine (e.g., a front side of a crankshaft) in order to absorb torsional vibration generated by the engine 10. The engine 10 selectively provides power to the transmission 20 via a coupling member 60 (e.g., a clutch or torque converter).

The damper 40 reduces torsional vibrations caused by torque transferred from the engine 10. The damper 40 may be a “dry” damper, without the presence of oil or fluid as in conventional torque converters with internal damper assemblies. The dry damper uses spring isolation between relevant components to dampen oscillations.

The damper 40 may include a retaining member having a plurality of spring pockets spaced at various radial distances around the retaining member. Resilient members, which in the dry damper are coil springs, are positioned in the spring pockets.

The present disclosure provides a compact arrangement of the powertrain that increases space in the engine room, reduces weight, and simplifies engine room layout, thereby providing improvements over the conventional arrangement.

### SUMMARY

The present disclosure provides a compact alternator integrating a damper for an engine to reduce parts and the mass of a powertrain.

In one form, the present disclosure provides an integrated alternator for a vehicle having an engine, and the integrated alternator may include: a stator including stator windings; a rotor disposed inside of the stator and including field windings and a damper layer configured to absorb vibration generated by the engine; a slip ring configured to supply a field current to the field windings; brushes configured to be in sliding contact with the slip ring; and a housing covering the stator, the slip ring, and the brushes and mounted on one side of the engine. In particular, the rotor is directly fixed on a crankshaft of the engine configured to rotate the rotor.

In one form, the rotor may include an inner core and an outer core enclosing the field windings.

The inner core may be rigidly fixed on the crankshaft by a keyway, a bolt or the like such that the crankshaft and the rotor rotate together.

In one form, the damper layer may be disposed between the inner core and outer core, and bond with the inner and outer cores so as to rotate together with the rotor.

In one aspect of the present disclosure, the damper layer may be made of a rubber material and is configured to allow the outer core to relatively move to the inner core to absorb the vibration generated by the engine.

In another aspect of the present disclosure, the field windings of the rotor is configured to electromagnetically communicate with the stator so as to generate electric power.

In still another form, the integrated alternator may be mounted on one side of the engine, and a coupling member configured to selectively connect the engine and the transmission may be disposed on an opposite side to the integrated alternator.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram illustrating a conventional arrangement of a powertrain;

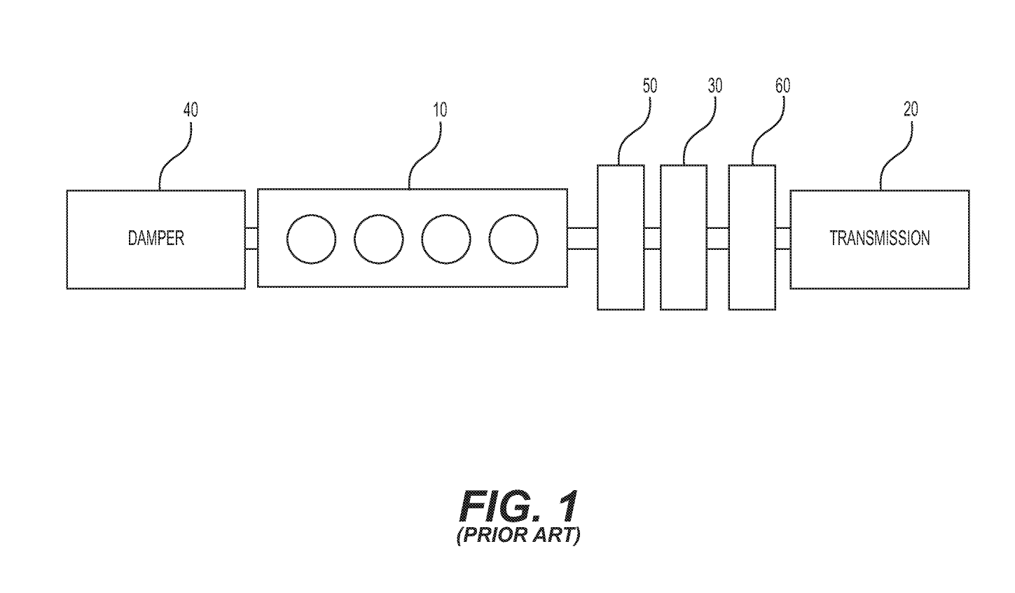

FIG. 2 is a schematic diagram illustrating an arrangement of a powertrain with an integrated alternator; and

FIG. 3 is a cross-sectional view of an integrated alternator mounted on an engine.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In describing the present disclosure, well-known configurations or functions will not be described in detail since they may unnecessarily obscure the gist of the present disclosure.

Terms used in the present disclosure are used only in order to describe specific exemplary forms rather than limiting the present disclosure. Singular forms are to include plural forms unless the context clearly indicates otherwise. It will be further understood that the terms “include” or “have” used in the present specification, specify the presence of features, numerals, steps, operations, components, parts mentioned in the present disclosure, or a combination thereof, but do not preclude the presence or addition of one or more other features, numerals, steps, operations, components, parts, or a combination thereof.

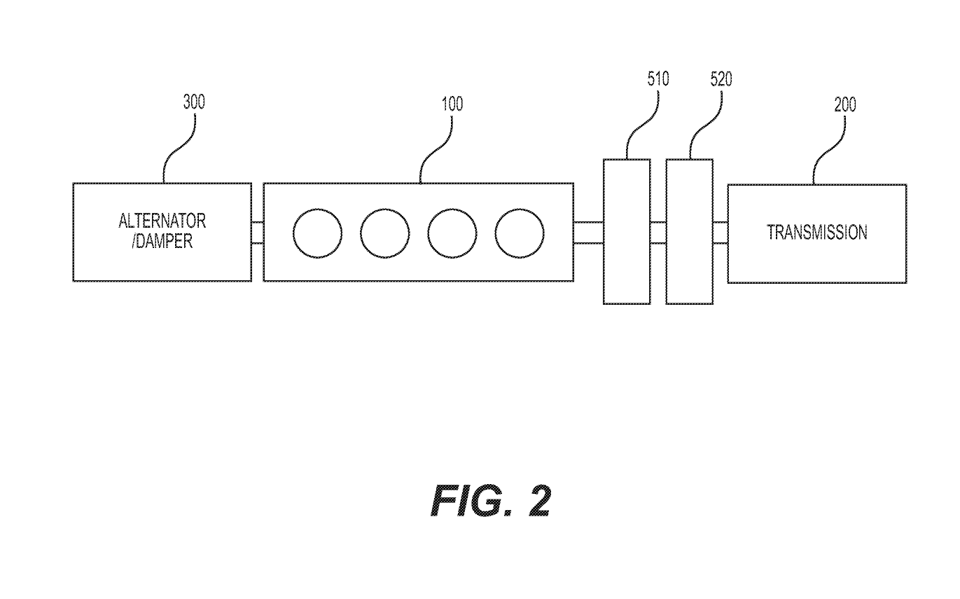

The present disclosure provides an alternator integrating the functions of an alternator and a damper as being connected to an engine. FIG. 2 is a schematic diagram illustrating an arrangement of a powertrain as one form of the present disclosure. As described in FIG. 2, the integrated alternator 300 may be mounted on one side of an engine 100, which is an opposite side to an engine side facing a flywheel 510 or a coupling member 520 that selectively connects the engine 100 and a transmission 200. In particular, a housing of the integrated alternator 300 is directly attached on the side of the engine 100.

With this arrangement, the present disclosure provides a compact powertrain layout which includes the integrated alternator 300, engine 100, the coupling member 520, and transmission 200. A separate damper mounted on an engine in a conventional powertrain layout is eliminated such that the overall length of the powertrain becomes short, and the parts and weight of the powertrain are reduced.

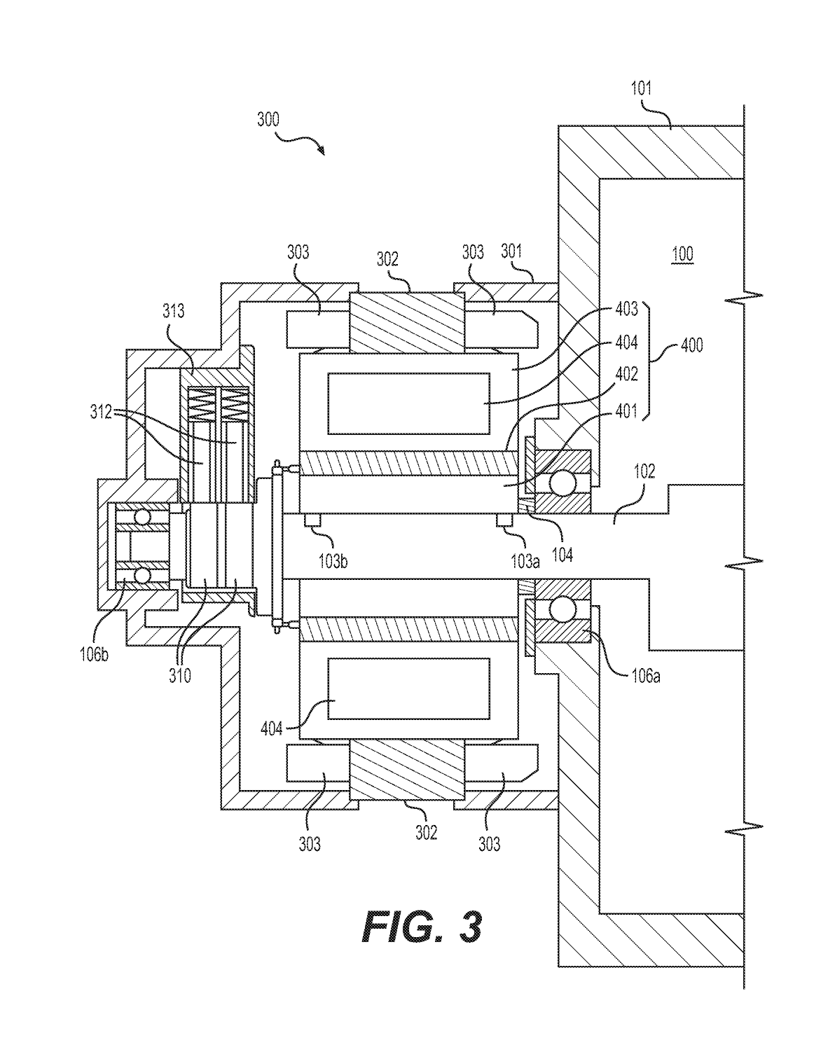

Detailed structure of the integrated alternator 300 will be described with reference to FIG. 3 which is a cross-sectional view of the alternator 300 in one form of the present disclosure. As illustrated in FIG. 3, the integrated alternator 300 is mounted on the engine (i.e., an engine block 101), and may include: a housing 301; a stator 302, a rotor 400 disposed inside of the stator 302; a slip ring 310; and brushes 312 which are in sliding contact with the slip ring 310. The stator 302 includes stator windings 303, and the rotor 400 includes field windings 404 that electromagnetically communicates with the stator 302 so as to generate electricity while the rotor rotates according to the operation of the engine 100. In particular, the rotor 400 is fixedly mounted on the crankshaft 102 of the engine and thus the rotation of the crankshaft is directly transferred to the rotor without involving any intermediate device such as a pulley or belt in a conventional alternator type. In one form, the stator 302 may be formed into a cylindrical shape and the stator windings 303 may be poly-phase stator windings. The stator 302 is mounted on the housing 301.

As illustrated in FIGS. 2 and 3, the housing 301 is directly mounted on one side of an engine block 101 of the engine 100, and covers the components of the integrated alternator 300 including the stator 302, the slip ring 310, bearings 106a, 106b, and a brush carrier 313 etc. At a rear end of the housing 310, the housing rotatably supports a nose part of the crankshaft 102 via a bearing 106b, and a front end of the housing is fixedly mounted on the engine block by a fixing device such as a bolt.

Referring to FIG. 3, the operation of the integrated alternator 300 to generate electricity will be described hereinafter. Field current is supplied to the field windings 404 via the brushes 312 and the slip ring 310, and the crankshaft 102 is driven as the engine runs. Here, the brushes 312 held by the brush carrier 313 are in sliding contact with the slip ring 310 which is fixedly mounted on the crankshaft 102. Then, AC power is generated in the stator windings 303. The AC power is rectified by a full-wave rectifier which may be incorporated into the alternator 300 and then used for charging a battery mounted on a vehicle and supplied to loads. A voltage control device may be incorporated in the alternator and turns on and off the field current to hold the output voltage to a predetermined value.

In addition to generating electricity as an alternator, the integrated alternator 300 also performs the function of damper by absorbing vibrations generated by the engine 100. The detailed structure of the integrated alternator 300 to dampen the vibration will be described with reference to FIG. 3.

As illustrated in FIG. 3, the rotor 400 includes an inner core 401, a damper layer 402, and an outer core 403 including the field windings 404. In particular, the inner core 401 is rigidly fixed on the crankshaft 102 by a keyway 103a, 103b, a bolt, or the like so that the inner rotor 401 and the crankshaft 102 rotate together. Since the inner core 401 and the crankshaft 102 rotate like one body, vibration generated by the operation of the engine 100 is directly transferred to the inner core 401. The transferred vibration is absorbed in the damper layer 402 which is disposed between the inner core 401 and outer core 403.

In particular, the damper layer 402 is securely bond with the inner core 401 and outer core 403 enough to transfer the rotation of the inner core 401 to the outer core 403, yet allows relative movement between the inner core 401 and outer core 403 via flexing of the damper layer. As such, the damper layer 402 allows a relative movement between the inner and outer cores 401, 403 in both radial and circumferential directions so that the damping function of the alternator 300 is improved. The relative movement should be limited to a certain amount as the damper layer is securely bonded with the inner and outer core 401, 403, and the relative movement may depend on the characteristics of the damper layer material. In one form, the damper layer is, but not limited to, made of a rubber material, but may also be made of various elastomers, plastics and/or hybrid materials that flex under force.

Based on the description above, it should be noted that even though the damper layer 402 allows a certain level of relative movement between the inner and outer cores 401, 403, the rotor 400 (i.e., inner core 401, damper layer 402, outer core 403) rotate together according to the rotation of the crankshaft 102 so that the rotor plays as one mass fixed on the crankshaft for the purpose of damping function. Various bonding techniques may be employed, such as friction welding, sonic welding, adhesives and the like.

As described above, since the rotor 400 includes the damper layer 402 and is directly fixed on the crankshaft 102, the integrated alternator performs as a generator as well as a damper. With this arrangement, the present disclosure provides a compact powertrain layout which includes the integrated alternator 300, engine 100, the coupling member 520, and transmission 200, by eliminating a separate damper mounted on an engine in a conventional powertrain layout. Furthermore, the elimination of a separate damper (i.e., an external damper) for an engine has the overall length of the powertrain be short and compact as well as the parts and weight of the powertrain are reduced. The eliminated parts are, for example, mounting brackets for a damper, a drive belt for the damper etc.

In addition, in terms of power delivery, due to the absence of the external damper, a drive belt for the damper does not need and thus drive losses caused by the drive belt while delivering drive power is prevented. The reduced mass and drive losses relating to driving an external damper contributes to improving fuel efficiency and NVH (i.e., Noise, Vibration, and Harshness) of the engine.

Although an exemplary form of the present disclosure has been described for illustrative purposes, those skilled in the art will appreciate that various modifications, additions and substitutions are possible, without departing from the scope and spirit of the present disclosure.

What is claimed is:

1. An integrated alternator for a vehicle having an engine, comprising:
a stator including stator windings;
a rotor disposed inside of the stator and including field windings contained within an inner core and an outer core, the rotor further including a damper layer positioned between the inner and outer cores and configured to absorb vibration generated by the engine;
a slip ring configured to supply a field current to the field windings;
brushes configured to be in sliding contact with the slip ring; and
a housing covering the stator, the slip ring, and the brushes and mounted on one side of an engine,
wherein the rotor is directly fixed on an crankshaft of the engine and configured to rotate with the crankshaft.

2. The integrated alternator of claim 1, wherein the outer core encloses the field windings.

3. The integrated alternator of claim 1, wherein the inner core is rigidly fixed on the crankshaft by a keyway or a bolt such that the crankshaft and the rotor rotate together.

4. The integrated alternator of claim 1, wherein the damper layer is disposed between and bonded with the inner core and outer core so as to rotate together with the rotor.

5. The integrated alternator of claim 4, wherein the damper layer is made of a rubber material and configured to allow the outer core to move relative to the inner core to absorb the vibration generated by the engine.

6. The integrated alternator damper of claim 1, wherein the field windings of the rotor are configured to electromagnetically communicate with the stator so as to generate electric power.

7. The integrated alternator damper of claim 1, wherein the integrated alternator is mounted on the one side of the engine, and a coupling member configured to selectively connect the engine and the transmission is disposed on an opposite side to the integrated alternator.
